(19) United States
(12) Patent Application Publication
(10) Pub. No.: US 2026/0093741 A1
(43) Pub. Date: Apr. 2, 2026

(54) PERFORMANCE OPTIMIZATION WITH REFLECTION TOKENS IN A SELF-REFLECTIVE RETRIEVAL-AUGMENTED GENERATION FRAMEWORK

(71) Applicant: Intuit Inc., Mountain View, CA (US)

(72) Inventors: Linoy COHEN, Petah Tikva (IL); Matan VETZLER, Ramat Gan (IL); Nitzan Gado SAGINHOR, Hod Sharon (IL); Shai ARDAZI, Petah Tikva (IL)

(73) Assignee: Intuit Inc., Mountain View, CA (US)

(21) Appl. No.: 18/902,882

(22) Filed: Sep. 30, 2024

(51) Int. Cl. G06F 16/33; G06F 40/284; G06F 40/30

(52) U.S. Cl. CPC G06F 16/3347; G06F 40/284; G06F 40/30

(57) ABSTRACT

A method includes obtaining data source tokens that identify corresponding data sources, and adding the data source tokens to a vocabulary list of a response tokenizer. An internal mapping of the response tokenizer is updated with the data source tokens, mapping each data source token to a corresponding token identifier (ID). Vector representations corresponding to the data source tokens are added to a response embedding model. The response tokenizer and the response embedding model are included in a response foundation model. An annotated dataset including multiple instances of an input utterances, retrieved data, and a data source token is created. The retrieved data is retrieved from a data source corresponding to the data source token. The response foundation model is trained with the annotated dataset to output data source tokens for a new input utterance based on a context of the new input utterance.

### BACKGROUND

Retrieval augmented generation (RAG) frameworks are frameworks for deploying pre-trained large language models (LLMs) on computing platforms serving thousands of clients via enterprise applications. In a RAG framework, the answer generation process of LLMs is augmented with additional reference documents or passages. The additional reference documents or passages are retrieved from external information sources. The external information sources may be relevant to the semantic context and intent of a prompt that is input to the LLM. The external information sources may encompass an enterprise’s proprietary knowledge bases, content stores, databases, etc. The retrieval is performed by a data retrieval application, or component, within the RAG framework. The prompt, and reference documents or passages are provided to the LLM. The LLM uses the reference documents or passages and its individual knowledgebase to generate a better-informed response to the prompt.

Current implementations of RAG frameworks face challenges in searching and assessing the quality of the retrieved reference documents, or passages. The relevancy of a reference document or passage to a prompt is based on a similarity between the reference document and the prompt. Relevancy searches are challenging to implement at scale for organizations storing vast amounts of information. Further, RAG frameworks currently implement retrieval of a fixed number of documents or passages, regardless of whether retrieval is necessary and without priority ordering. An unordered set of retrieved documents or passages may lead to unhelpful response generation.

Self-reflective retrieval augmented generation (self-RAG) frameworks adaptively retrieve documents, or passages of documents, on demand, and evaluate this retrieved information. Self-RAG frameworks further evaluate corresponding response segments generated by the LLM based on the retrieved information.

Enterprises with product offerings of specialized enterprise applications have knowledge bases of specific domains. Training or fine-tuning a commercial pre-trained LLM on these domain knowledge bases is a technical and operational challenge. Further, current implementations of self-RAG frameworks may maintain a single dataset for different knowledge domains. All documents for various knowledge domains may be indexed into a single index, resulting in an inefficient retrieval of irrelevant information. In such implementations, security of the system may be compromised as data-leakage may occur across diverse client-specific domain data sources.

### SUMMARY

In general, in one aspect, embodiments relate to a method. The method includes obtaining data source tokens that identify corresponding data sources, and adding the data source tokens to a vocabulary list of a response tokenizer. The method further includes updating an internal mapping of the response tokenizer with the data source tokens to map each data source token to a corresponding token identifier (ID). The method further includes adding vector representations corresponding to the data source tokens to a response embedding model. The response tokenizer and the response embedding model are included in a response foundation model. The method further includes creating an annotated dataset including multiple instances. Each instance includes an input utterance, a retrieved data, and a data source token. The retrieved data is retrieved from a data source corresponding to the data source token. The method further includes training the response foundation model with the annotated dataset to output data source tokens for a new input utterance based on a context of the new input utterance.

In general, in one aspect, embodiments relate to a method. The method includes augmenting a prompt with at least one new data source token by a response foundation model of a response generator. The method further includes retrieving at least one new retrieved data from a new data source identified by the new data source token by a document retriever. The document retriever is invoked by the response generator. The method further includes generating a first response segment based on the at least one new retrieved data by the response foundation model. The method further includes evaluating, by the response generator, a relevance of the first response segment. The method further includes evaluating, by the response generator, a validity of the first response segment. The method further includes evaluating, by the response generator, a utility of the first response segment, based on the relevance of the first response segment and the validity of the first response segment. The method further includes augmenting the first response segment with a second new data source token by the response foundation model responsive to a determination of an additional retrieval based on a context of the first response segment.

In general, in one aspect, embodiments relate to a system. The system includes a memory and at least one processor, configured to execute instructions for causing the system to perform operations including augmenting a prompt with at least one new data source token by a response foundation model of a response generator. The system further performs operations including retrieving at least one new retrieved data from a new data source identified by the new data source token by a document retriever invoked by the response generator. The system further performs operations including generating a first response segment based on the at least one new retrieved data by the response foundation model. The system further performs operations including evaluating, by the response generator, a relevance of the first response segment. The system further performs operations including evaluating, by the response generator, a validity of the first response segment. The system further performs operations including evaluating, by the response generator, a utility of the first response segment, based on the relevance of the first response segment and the validity of the first response segment. The system further performs operations including augmenting the first response segment with a second new data source token by the response foundation model, responsive to a determination of an additional retrieval based on a context of the first response segment.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a sequence diagram, in accordance with one or more embodiments.

FIG. 3 shows a flowchart of a method, in accordance with one or more embodiments.

FIG. 4 shows a flowchart of a method, in accordance with one or more embodiments.

FIG. 5 shows an example of an annotated dataset and data source token injection, in accordance with one or more embodiments.

FIG. 6A and FIG. 6B show a computing system, in accordance with one or more embodiments.

Like elements in the various figures are denoted by like reference numerals for consistency.

### DETAILED DESCRIPTION

One or more embodiments are directed to adding a new type of reflection token in a self-RAG framework. The new type of reflection token is a data source token that specifically identifies corresponding data sources. A foundation large language model (foundation model) of a response generator is trained to analyze a prompt and identify and inject the data source tokens into the prompt based on the context of the prompt. Using the data source token, the documents may be retrieved from the data source.

In an inference phase, the trained foundation model injects a received prompt with data source tokens, resulting in an augmented prompt. The response generator invokes a document retriever to retrieve information including documents or passages from the data source identified by the data source token(s). Response segments are generated, based on the retrieved information, by the foundation model. Response segments are parts of the final response generated by the foundation model. A response segment may be generated from the retrieved information corresponding to a data source identified by a data source token. The response generator further evaluates the generated response segments for relevancy, validity, and utility, against the prompt and corresponding retrieved information. The foundation model consequently determines if there is a need for retrieval from additional data sources.

If the evaluation of the generated response segment(s) indicates a need for additional retrieval, the foundation model injects additional data source tokens into the generated response segments. The response generator again invokes the document retriever to retrieve additional information. The iterative process of retrieval and response (segment) evaluation continues, halting when an optimal response is generated from the response segments.

In one or more embodiments, the data sources are grouped by application domains. Thus, a data source token identifies a data source of an application domain. The data sources are further separated by specific topics or sub-domains. For example, a federal tax documentation data source may be logically indexed and separated from state tax documentation data sources, within an application domain of tax filing.

The logical indexing and separation of data sources optimizes and hastens the data retrieval process. Further, the logical indexing and separation of the data sources guarantees a retrieval of documents and passages related exclusively to the data source sub-type within a domain. For example, a retrieval from the federal tax documentation data source may not include information related to California tax code. The focused retrieval increases the precision and accuracy of generated responses based on the documents or passages retrieved from the data sources. Further, the separation of data sources within an application domain increases data security, providing the capability to safely use customer-specific data across different products with a reduced risk of data leakage.

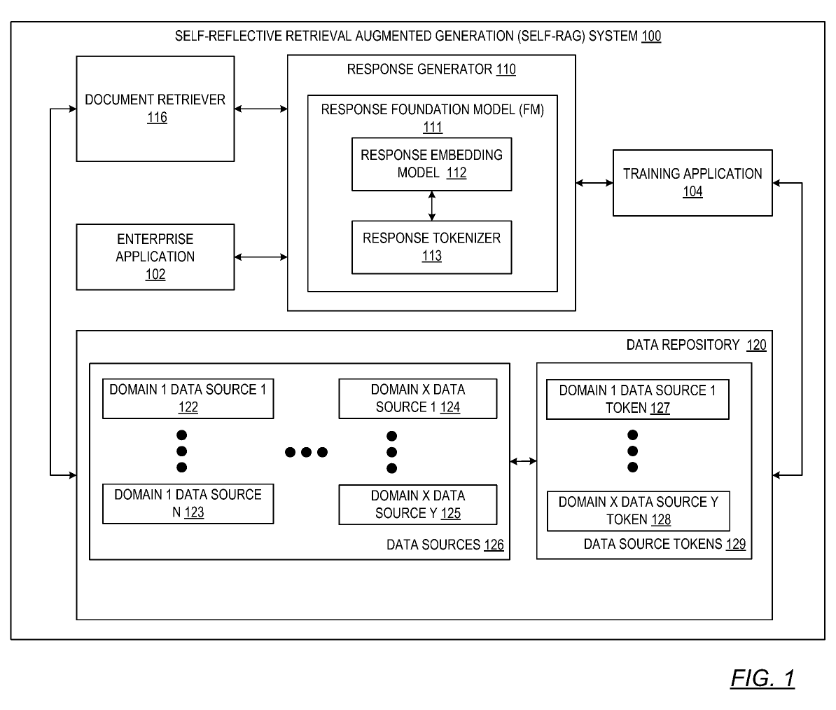

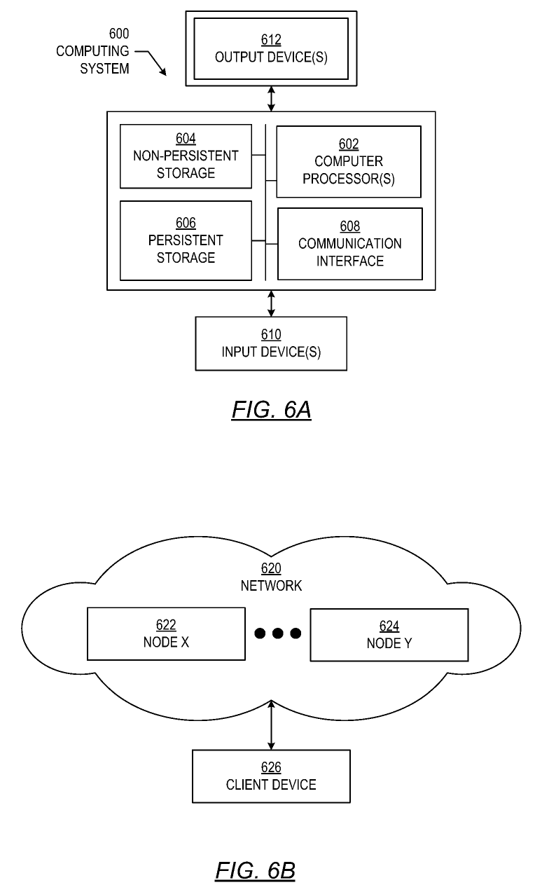

Attention is now turned to the figures. FIG. 1 shows a self-reflective retrieval augmented generation (self-RAG) system (100), in accordance with one or more embodiments. The self-RAG system (100) is one or more computer processors, data repositories, communication devices, and supporting hardware and software. The self-RAG system (100) may be in a distributed computing environment. An example of a computer system and network that may form the self-RAG system (100) is described with respect to FIG. 6A and FIG. 6B. The computer processor is one or more hardware or virtual processors which may execute computer readable program code that defines one or more applications, such as. An example of the computer processor is described with respect to the computer processor(s) (602) of FIG. 6A.

The self-RAG system (100) shown in FIG. 1 includes a data repository (120). The data repository (120) is a type of storage unit or device (e.g., a file system, database, data structure, or any other storage mechanism) for storing data. The data repository (120) may include multiple different, potentially heterogeneous, physical, and logical storage units and/or physical storage devices.

The data repository (120) includes one or more data sources (126). The one or more data sources are physically or logically grouped by an application domain. An application domain refers to the general field of use of the application. For example, domain 1 may correspond to the application domain of tax filing. In the example, domain 1 data source 1 (122) may include documents related to federal tax code. Domain 1 data source N (123) may include documents related to California tax code. As another example, domain X may correspond to the application domain of financial management. Similarly, domain X data source 1 (124) may include documents related to credit scores and reports, while domain X data source Y (125) may include credit card and loan ratings and recommendations. The data sources may be stored in data structures (e.g., files and directories, databases), or in specialized vector stores, for example, Pinecone^{®}, Weaviate^{®}, Elasticsearch^{®}, Milvius™, etc.

The data repository (120) further includes one or more data source tokens (129). The data source tokens each identify a corresponding data source of a domain. Each data source token is a numeric, alphabetic, or alphanumeric identifier of the corresponding data source that may be added to a prompt. For example, domain 1 data source 1 token (127) identifies domain 1 data source 1 (122). Similarly, domain X data source Y token (128) identifies domain X data source Y (124). The data source tokens may be a coded string of alpha-numeric or special characters that identify a corresponding domain data source. Further, the data source tokens may be stored in data structures such as arrays, lists, data frames, etc.

The self-RAG system (100) further includes one or more enterprise application(s) (102). The enterprise application (102) is a set of programs and code that includes functionality to manage business operations, or provides products and features to users, related to a particular domain. For example, an accounting application that executes on the self-RAG system may have features and functions for management for the finances of an organization. A tax filing software application for users, hosted on the self-RAG system may be another example of the enterprise application (102). Thus, one or more different types of enterprise application (102) may be operational in the self-RAG system (100).

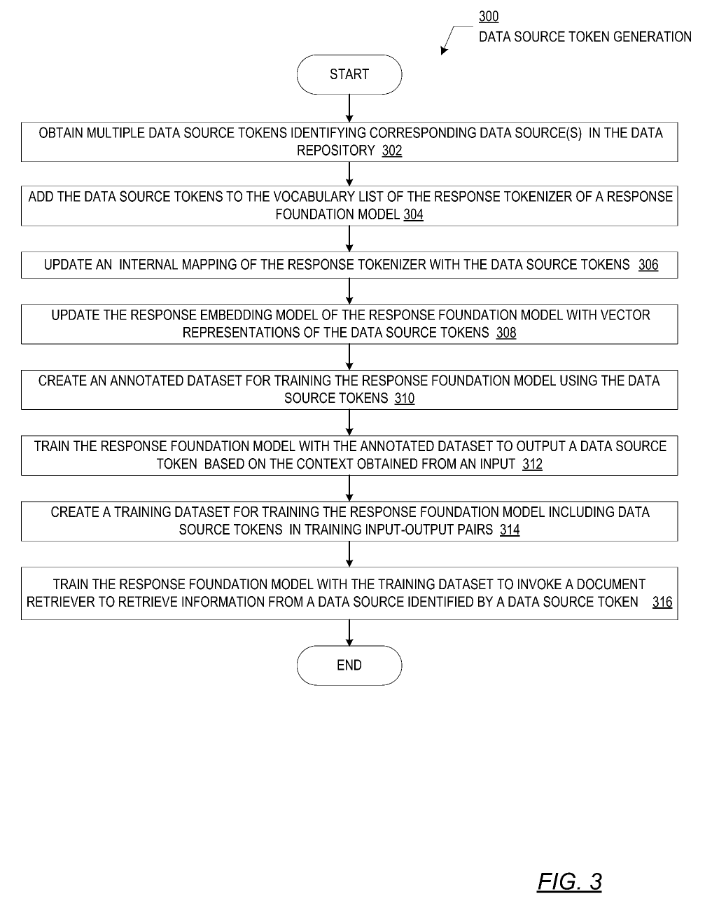

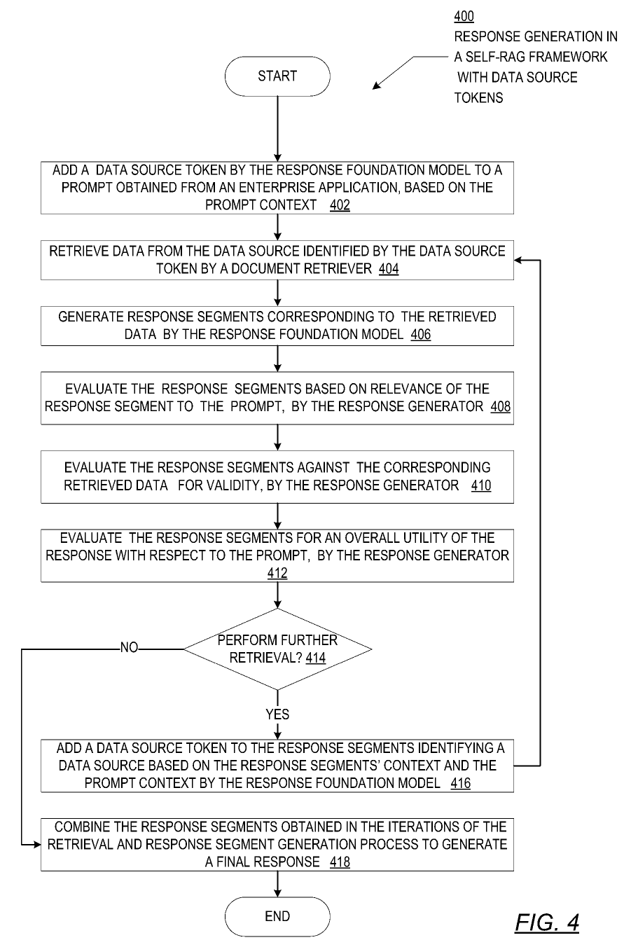

The self-RAG system (100) further includes a training application (104). The training application (104) is a set of programs and code that is configured for training the response generator (110). In one or more embodiments, the training application (104) may orchestrate an LLM (not shown) to generate a training dataset for the response generator (110). The training application (104) is described in further detail in reference to the methods of FIG.3 and FIG. 4.

The self-RAG system (100) further includes a response generator (110). The response generator (110) is a set of programs and code, configured for processing an augmented prompt with injected reflection and data source tokens to generate a response. In one or more embodiments, the response generator (110) may be further configured to orchestrate a document retriever (116) to retrieve documents or passages from the data sources identified by the data source tokens. The documents or passages are referred to as retrieved information or retrieved data. The response generator (110) includes a response foundation model (111). The response foundation model (111) is a large language model. Foundation models are trained on vast amounts of data, and hence may perform well generally, across different tasks, but may also be fine-tuned for specific applications. Examples of foundation models include ChatGPT^{®}, Llama^{®}, Claude^{®}, etc. In FIG. 1, the response foundation model (111) is specifically shown to include a response embedding model (112) and a response tokenizer (113). In general, foundation models include several additional layers, for example, attention layers, encoder layers, decoder layers, etc. However, in FIG. 1, the tokenizer and embedding model layers are specifically represented because they are modified in order for the foundation model to recognize data source tokens. The response generator (110) may be further configured to evaluate response segments generated by the response foundation model (111). The response generator (110) may be further configured to orchestrate a training application (104) to train the response foundation model. The response generator (110) may further include functionality to orchestrate the response foundation model (111) to iteratively evaluate response segments and inject data source tokens until an optimal response is obtained.

The self-RAG system (100) further includes a document retriever (116). The document retriever is an application or an application stack that retrieves documents and passages from one or more data sources (126). The document retriever (116) may be invoked by the response generator (110) in an inference and/or training phase of the self-RAG system (100). An example of document retriever (116) application stack includes Haystack, which uses BM25 as a retriever component and BERT as a reader component. Another example of a document retriever (116) is ColBERT.

While FIG. 1 shows a configuration of components, other configurations may be used without departing from the scope of one or more embodiments. For example, various components may be combined to create a single component. As another example, the functionality performed by a single component may be performed by two or more components.

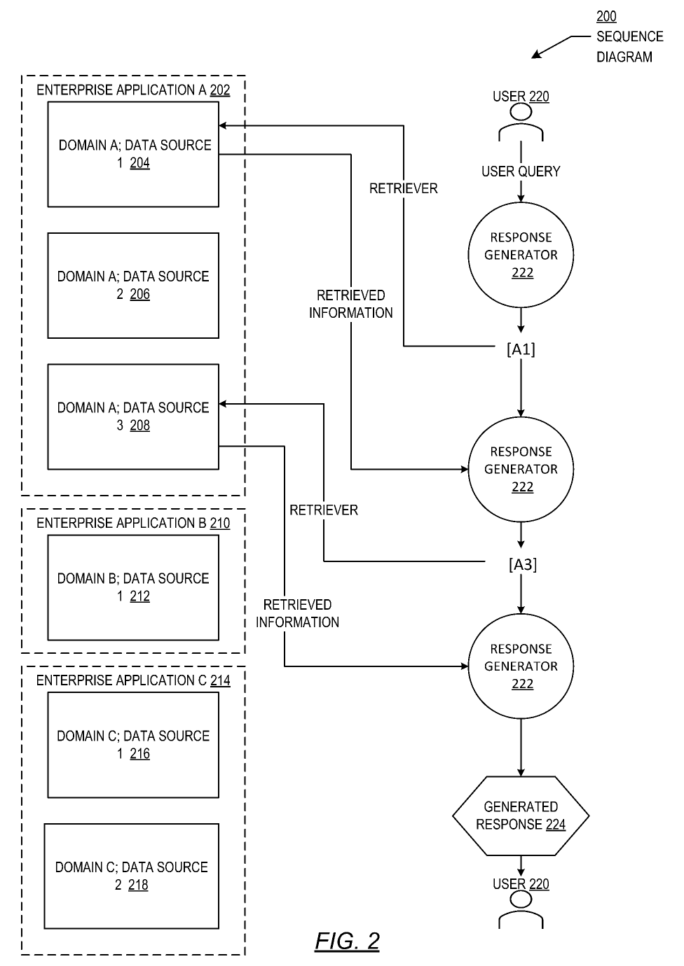

FIG. 2 shows a sequence diagram of an execution workflow of the self-RAG framework with data source tokens. In FIG. 2, enterprise application A (202) is a grouping of data sources for the domain A of the enterprise application A (202). The data sources for enterprise application A (202) include domain A; data source 1(204), domain A; data source 2 (206) and domain A; data source 3 (208). In a similar manner, enterprise application B (210) is a grouping for data sources corresponding to domain B of enterprise application B (210). In this case, there is a single data source, namely, domain B; data source 1 (212) for enterprise application B (210). Likewise, enterprise application C (214), is a grouping of data sources corresponding to domain C of enterprise application C (214), including domain C; data source 1 (216) and domain C; data source 2 (218).

In FIG. 2, the sequence of events is initiated when a user (220) sends a user query to the response generator (222). The response foundation model of the response generator (222) processes the user query and may determine that a retrieval of additional documents or passages from a particular data source may enhance the quality of a generated response. Accordingly, the response foundation model of the response generator (222) may determine that the data source token A1, identifying domain A; data source 1 (204) is to be injected into the prompt.

The response generator (222) invokes the document retriever, and information is subsequently retrieved and sent to the response generator (222). The response foundation model of the response generator generates a response segment based on the retrieved information from domain A; data source 1 (204). In generating the response segment and evaluating the context of the response segment, the response foundation model of the response generator (222) may determine that additional retrieval is needed to generate the complete response. In the sequence diagram, an additional data source token, namely A3 is injected into the generated response segment. The data source token A3 identifies domain A; data source 3 (208).

The retriever is again invoked, and additional information is retrieved from domain A; data source 3 (208). The response foundation model of the response generator (222) generates an additional response segment based on the retrieved information from domain A; data source 3 (208). In evaluating the additional response segment, the response foundation model of the response generator (222) may determine that the no further retrieval is necessary, and the response is complete in terms of relevance, validity, and overall utility. The response foundation model of the response generator may combine the generated response segments and send the generated response (224) to the user (220).

Notably, when the trained response foundation model processes a prompt, more than one data source token may be injected into the prompt. For example, the response foundation model of the response generator may inject data source tokens A1, B1, and C2 into the prompt. In this case, retrieval may be performed on domains, A, B and C, to retrieve information from domain A; data source 1, domain B; data source 1, and domain C; data source 2, respectively. Response segments corresponding to the retrieved information from each data source may be generated. In generating the response segments, the response foundation model of the response generator (222) may determine that additional retrieval is required for the response segment corresponding to retrieved information from domain A; data source 1, namely, domain A; data source 3. However, the response foundation model of the response generator (222) may determine that no further retrieval is necessary for the response segments corresponding to domain B; data source 1, and domain C; data source 2. Hence, the second phase of retrieval may be from domain A; data source 3. Subsequently, the final response may be generated.

FIG. 3 shows a flowchart of a method for data source token generation, in accordance with one or more embodiments. The method of FIG. 3 may be implemented using the system of FIG. 1 and one or more of the steps may be performed on or received at one or more computer processors. While the various steps in flowchart 300 are presented and described sequentially, at least some of the steps may be executed in different orders, may be combined, or omitted, and at least some of the steps may be executed in parallel. Furthermore, the steps may be performed actively or passively.

During training, the response foundation model of the response generator learns to generate reflection tokens based on the input query and generate the final response based on the context of the input query and retrieved data. The retrieved data is retrieved from documents and passages of data sources identified by data source tokens. Thus, the response foundation model is initially fine-tuned to recognize and decode data source tokens, and inject the data source tokens into a prompt, or user query. The response foundation model is then trained to learn which data source token to inject into the prompt based on the context of the prompt and exemplary retrieved data corresponding to diverse data sources. Subsequently, the response foundation model is trained to perform processing of data source tokens by invoking the document retriever to retrieve information from data sources identified by the data source tokens. Further the response foundation model may be trained to generate response segments based on the retrieved information. Alternatively, or additionally, the response foundation model may be prompted to generate the response segments based on the retrieved information.

In Block 302, multiple data source tokens identifying corresponding data source(s) in the data repository are obtained. In one or more embodiments, developers may use the training application to create the data source tokens. A given data source token may uniquely identify a domain specific data source. For example, in FIG. 1, “domain 1 data source 1 token” may uniquely identify the “domain 1 data source 1” data source.

In Block 304, the data source tokens are added to the vocabulary list of a response tokenizer of a response foundation model. As a general overview, tokenizers in large language models break down text into smaller units referred to as tokens. A tokenizer of an LLM may receive raw text as input and apply a specific algorithm, for example, byte pair encoding, WordPiece or SentencePiece to split the text into tokens. The tokenizer maintains a vocabulary of tokens that the LLM can understand. The vocabulary is built during the training phase of the LLM and includes the most frequent tokens in the training data. Accordingly, in one or more embodiments, the data source tokens may be added to the vocabulary list of the response tokenizer of the response foundation model.

In Block 306, an internal mapping of the response tokenizer is updated with the data source tokens. In one or more embodiments, the training application may map each data source token to a corresponding token identifier (ID).

In the mapping process, each data source token is converted into a numerical representation (token ID) that is understood by the response foundation model. Thus, if, in an inference phase, the response tokenizer receives raw text interleaved with data source tokens as input, the output of the response tokenizer is a sequence of token IDs. The token IDs are fed to the response embedding model for further processing.

In Block 308, the response embedding model of the response foundation model is updated with vector representations of the data source tokens. In one or more embodiments, vector representations corresponding to the data source tokens may be added to the response embedding model of the response foundation model.

In LLMs, embedding models take the output of tokenizers (token IDs) and convert the token IDs into dense, high-dimensional vectors known as embeddings. The embeddings capture semantic information about the tokens. The embeddings are then fed into additional layers of the LLM, for example, attention layers, encoding layers, and decoding layers to perform tasks of text generation, translation or question answering. In one or more implementations, vectors generated by embedding models may be stored in embedding matrices of the embedding models. Each row in an embedding matrix may correspond to the vector representation of a token. Accordingly, in one or more embodiments, the process of updating the response embedding model with vector representations of the data source tokens may entail re-allocating or initializing new rows in an embedding matrix of the response embedding model.

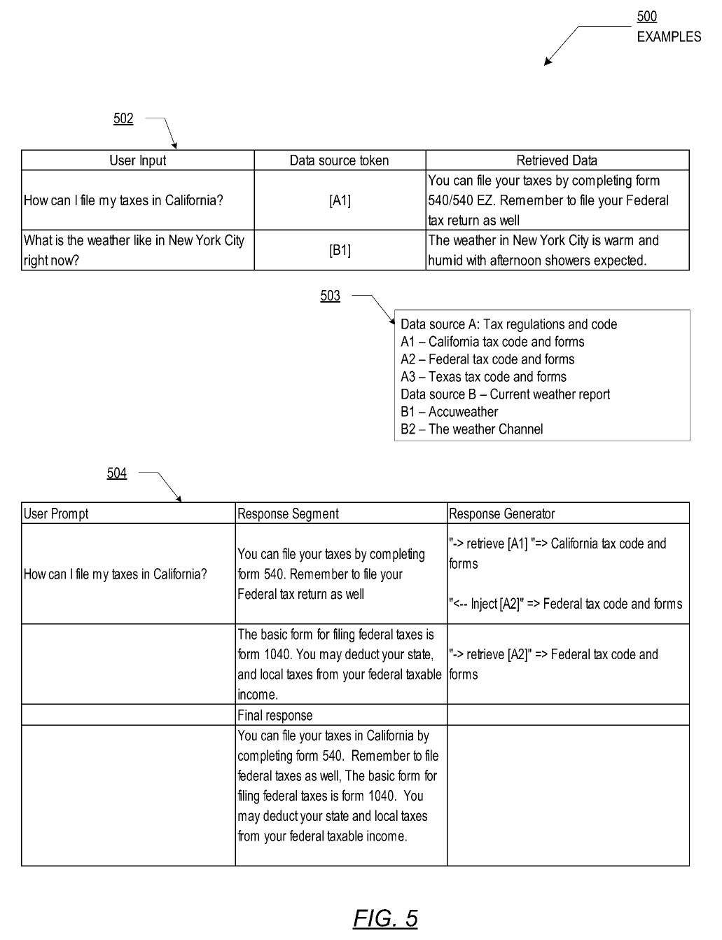

In Block 310, an annotated dataset is created for training the response foundation model using the data source tokens. In one or more embodiments, the annotated dataset may include multiple instances. Each instance may include an input utterance, a data source token, and a retrieved data. The retrieved data may be retrieved from a data source that is determined to be the object of the detected intent of the input utterance. The data source token may identify the data source. The data source may, in turn, correspond to a context and/or intent of the input utterance. For example, if the input utterance is “What is the weather in New York City right now,” the detected intent may be a weather report at the current time in New York City. Accordingly, the data source chosen may be a weather reporting source. The retrieved data from the weather reporting source may be a weather report summary for the present time in New York City. An example of the annotated dataset is shown in FIG. 5.

In one or more embodiments, the training application may use a pre-trained LLM, for example, ChatGPT-4^{®} to create the annotated dataset. The training application may provide the LLM with a prompt including few-shot examples of annotated instances, and a set of definitions for the data source tokens. The prompt may further include an instruction to process multiple unseen instances by assigning corresponding data source tokens, based on the few-shot examples and the data source token definitions. The creation of the machine-generated annotated dataset may entail the LLM determining the context and intent of the input utterance and output response of a given instance, and based on this determination, assigning a data source token to the instance. In other embodiments, the training dataset may be programmatically generated by the training application.

As a general overview, the context of an input utterance and output response refers to the encompassing information that provides background and meaning to the input utterance. The context may include previous interactions with the LLM, providing a view into the flow and continuity of the interaction and the input utterance and output responses’ place in that flow. Further, the context may include any additional data or knowledge that the LLM has a priori access to, that may influence the LLMs understanding of the current input utterance and output response. Additionally, information about the user/provider of the input utterance may be included in the context. The context, taken together with the intent of an input utterance, may inform the determination of whether additional retrieval from a data source is needed. The intent of an input utterance is the underlying goal or purpose of the input utterance. An intent may be considered in terms of an objective and an actionable task. For instance, if an input utterance is "What is the weather like today?” the intent may be to get the current weather information. The context, however, may include previous questions about travel plans to a local destination. Thus, a relevant response may include both the current weather information and travel suggestions or advisories (e.g., “take private transport or a taxi; local trains may be delayed”).

Accordingly, in an example workflow, the training application may provide a prompt to the pre-trained LLM to create the annotated dataset. The prompt may include an instruction, for example:

“Given the sample instance(s) and corresponding data source tokens, < annotated few-shot examples> assign the data source token for the following instances. The data source tokens are defined as follows: <data source token list and corresponding data source>.”

In one or more embodiments, the LLM may assign the data source token based on the intent of the input utterance, informed by the context of the output response. For example, if the input utterance is “How do I file my taxes in California,” and the output response is “You may file your taxes in California by submitting form 540. The forms are available on the California Franchise Tax board website,” the LLM may assign a data source token “A1” to the input-potential response pair. In the data source token definitions, the token “A1” may correspond to the California Franchise Tax board documentation.

In Block 312, the response foundation model is trained with the annotated dataset of Block 310 to output data source tokens for a new input utterance, based on a context of the new input utterance. In one or more embodiments, the response foundation model may be trained by maximizing a conditional language modeling objective. Further, a next token prediction loss function may be applied to evaluate how well the response foundation model is achieving the conditional language modeling objective. In one or more embodiments, the weights, and parameters of the response foundation model may be adjusted to minimize a next token prediction loss function value.

A conditional language modeling objective predicts the next token in a sequence, given the previous tokens. A goal of the conditional language modeling objective is to maximize the probability of the next token given the preceding context. Next token prediction loss is the metric used to evaluate how well the model is achieving the conditional language modeling objective. By minimizing this loss, the model improves its ability to predict the next token accurately. An example of a conditional language modeling objective may be a maximum likelihood estimation (MLE) objective. An example of a next token prediction loss function may be a cross entropy loss function.

In Block 314, a training dataset is created for training the response foundation model. The training dataset includes multiple training input-output pairs. The training input includes at least one training data source token. In one or more embodiments, the training input may be augmented with at least one training data source token by the training application. The training data source token may be selected based on a training context of the training input and the training output. The training output may include a training retrieved data. The training retrieved data may be retrieved from a training data source corresponding to, or identified by, the training data source token.

In a comparable manner to creating the annotated dataset of Block 310, in one or more embodiments, the training application may use a pre-trained LLM, for example, ChatGPT-4^{®} to create the training dataset. The training application may provide the LLM with a prompt including few-shot examples of training input-output pairs, and a set of definitions for the data source tokens. The prompt may further include an instruction to process multiple unseen training input-output pairs by assigning corresponding data source tokens, based on the few-shot examples and the data source token definitions. The creation of the machine-generated training dataset may entail the pre-trained LLM determining the context and intent of the training input and training output of a given training input-output pair, and based on this determination, injecting a data source token to the training input to create the augmented training input.

In Block 316, the response foundation model is trained with the training dataset from Block 314 to invoke a document retriever to retrieve information from a data source identified by a data source token. More particularly, in one or more embodiments, the response foundation model may be trained with the training dataset to output a response segment. In one or more embodiments, the response foundation model may be trained to invoke a document retriever to retrieve data from a data source identified by a training data source token in a training input of the training dataset. In one or more embodiments, the response generator may receive an indication from the response foundation model for retrieval from the data source. The response generator may in turn, invoke the document retriever to retrieve the data from the data source. The response foundation model may further be trained to generate the response segment based on the training input and the retrieved data.

In one or more embodiments, the steps of Block 316 may be accomplished by prompt engineering. For example, the response foundation model may be provided with a few-shot examples from the training dataset, and instructions to process the training data source token included in a training input of the training dataset by indicating to the response generator that a document retriever is to be invoked to retrieve data from a data source identified by the training data source token. The retrieved data from the data source may be ascertained by the document retriever to have relevance to the context of the training input. The response foundation model may be further prompted by the response generator to generate a response segment based on the training input and the retrieved data.

FIG. 4 shows a flowchart 400 of a method for response generation in a self-RAG framework with data source tokens. The method of FIG. 4 may be implemented using the system of FIG. 1 and one or more of the steps may be performed on or received at one or more computer processors. While the various steps in flowchart 400 are presented and described sequentially, at least some of the steps may be executed in different orders, may be combined, or omitted, and at least some of the steps may be executed in parallel. Furthermore, the steps may be performed actively or passively.

The method of flowchart 400 may be performed in an operation phase of the response generator, subsequent to the training of the response foundation model in accordance with flowchart 300. The flowchart 400 starts at Block 402. In Block 402, a data source token is added by the response foundation model to a prompt obtained from an enterprise application, based on the prompt context. In one or more embodiments, the prompt may be received by the response generator from an enterprise application. The response foundation model may determine a context of the prompt. The response foundation model may further augment the prompt with the at least one new data source token, based on the context of the prompt.

In Block 404, data from the data source identified by the data source token is retrieved by a document retriever. The retrieved data may be retrieved information from the data source. In one or more embodiments, at least one new retrieved data may be retrieved from a new data source by the document retriever. The new data source may be identified by the new data source token included in the augmented prompt, received from the enterprise application. In one or more embodiments, the response foundation model may indicate to the response generator that the document retriever is to be triggered, and identify the data source from which the document retriever is to retrieve the data. For example, the response generator may include an LLM agent that programmatically interacts with the foundation model via application programming interface (API) calls. In another example, the response generator may programmatically interact with the response foundation model via machine-generated prompts, with instructions to indicate a document retrieval operation and the target data source when the response foundation model recognizes a data source token. Further, the response generator may invoke the document retriever with one or more parameters indicating at least the data source, the prompt context, etc., to retrieve the data.

In Block 406, response segments to the prompt corresponding to the retrieved data are generated by the response foundation model. In one or more embodiments, the prompt from the enterprise application and at least one new retrieved data may be received from the document retriever by the response generator. The at least one new retrieved data may correspond to the new data source identified by the new data source token, as described in Block 404. In one or more embodiments, a first response segment may be generated by the response foundation model, based on the at least one new retrieved data. The first response segment may be a first part of a response corresponding to the prompt.

In Block 408, the response segments are evaluated for relevance of the response segments to the prompt by the response generator. In one or more embodiments, a relevance of the first response segment may be evaluated based on the first response segment and the prompt, by the response generator. More particularly, the relevance may be computed using the new retrieved data, the query of the prompt, and the first response segment.

In one or more embodiments, the relevance of the response segment may be determined as the mean cosine similarity of the query of the prompt to one or more artificial “queries” generated by reverse engineering the response segment. A response segment may be deemed relevant when it directly and appropriately addresses the query of the prompt. In one or more embodiments, the response foundation model may be prompted to generate one or more queries for the first response segment. The mean cosine similarity between embeddings (vectors) corresponding to the generated queries and the query of the prompt may be determined. The underlying idea is that the response foundation model would generate queries from the response segment that align with the query of the prompt. In certain embodiments, if the vectors are pointing in the same direction, the cosine similarity value may be close to 1 and may indicate a high similarity. If the vectors are perpendicular, the cosine similarity value is 0, and may indicate a low similarity and/or relevance. If the vectors point in opposite directions, the cosine similarity value is -1, and may indicate semantically opposite meanings.

In Block 410, the response segment is evaluated against the corresponding retrieved data for validity by the response generator. In one or more embodiments, a validity of the first response segment may be evaluated by the response generator. In one or more embodiments, validity may be based on the semantic similarity of the first response segment to the at least one new retrieved data of the new data source identified by the new data source token in the prompt, from Block 404.

The validity of a response segment may be defined as a measure of the factual consistency between the response segment and the new retrieved data. The validity of a response segment may be referred to as “faithfulness.” A response segment may be deemed as faithful if the facts of the response segment may be inferred from the new retrieved data. In certain additional embodiments, validity may be determined by a classifier model, for example HHEM 2.1-open from Vectara^{®}, which may be programmatically invoked by the response generator.

In Block 412, the response segment(s) may be evaluated for overall utility of the response with respect to the input by the response generator. In one or more embodiments, the response generator may evaluate a utility of the first response segment, based on the relevance of the first response segment and the validity of the first response segment obtained in Blocks 408 and 410.

A determination of response utility involves several factors, for example, relevance, accuracy pertaining to correctness and reliability, completeness covering all aspects of the prompt, etc. Additional factors of clarity and conciseness may also be considered. Various metrics and techniques for scoring these factors may be applied, including automated scoring systems, Reinforcement Learning based on Human Feedback (RLHF), user interaction data, etc. Automated scoring systems may use Natural Language Processing techniques to train machine learning models to score responses based on training datasets previously scored by human evaluators.

In one or more embodiments, the utility score of a given response segment may be a consideration for the inclusion of the response segment in a final response.

In Block 414, a determination is made by the response foundation model for additional retrieval, based on the context of the first response segment. In one or more embodiments, the first response segment may provide additional context which may be entail additional retrieval. For example, if the first response segment is generated in response to a prompt “How do I file my taxes in California?” and the first response segments includes the content “Remember to file your federal taxes as well,” the first response segment includes additional context. This additional context may entail further retrieval of data from a data source encompassing federal tax codes, forms, and procedure. Thus, in this example, the response foundation model may augment the first response segment with a second data source token identifying the second data source of federal tax codes, forms, and procedure. In one or more embodiments, the response generator may prompt the response foundation model, for example, via an LLM agent, to determine if additional retrieval is needed based on the context of the first response segment.

In one or more embodiments, in Block 414, responsive to a determination of additional retrieval based on the context of the first response segment, control may pass to Block 416.

In Block 416, a data source token identifying a data source may be added to the response segment(s), based on the response segment context and the prompt context, by the response foundation model. In one or more embodiments, the response foundation model may identify a second new data source based on the context of the first response segment. Further, the response foundation model may augment the first response segment with a second new data source token identifying the second new data source. Consequently, at least a second new retrieved data may be retrieved from a second new data source identified by the second new data source token. Furthermore, a second response segment may be generated based on at least the second new retrieved data, by the response generator. Blocks 404-416 may be iterated in this manner until a determination precluding additional retrieval is made by the response foundation model.

Accordingly in Block 414, responsive to a determination precluding additional retrieval made by the response foundation model, control passes to Block 418. In Block 418, the response segments obtained in the iterations of the retrieval and response segment generation process, namely Blocks 404-416, are combined to generate a final response. In one or more embodiments, the final response may include previous response segments generated in the previous iterations of Blocks 404-416, and may be transmitted to the enterprise application by the response generator. The inclusion of a given response segment may depend on the utility of the response segment. In one or more embodiments, the final response segment may include at least the first response segment and the second response segment, based on a first utility of the first response segment and a second utility of the second response segment.

FIG. 5 shows an example of an augmented dataset shown in Block 502, in accordance with one or more embodiments. FIG. 5 additionally shows an example of retrieval of data based on a data source token and injection of an additional data source token based on the context of the first response segment, shown in Block 504. The following example is for explanatory purposes only and not intended to limit the scope of one or more embodiments.

In Block 502, an example user input is shown, “How can I file my taxes in California”. The annotated dataset shows corresponding retrieved data “You can file your taxes in California by filing form 540. Remember to file your federal tax returns as well.” The data source token provided is [A1]. In Block 503, A1 is shown as the data source for California tax code and forms. Similarly, the second example in Block 502 pertains to a weather query, and a corresponding data source token [B1] is provided. The example retrieved data from B1 is shown in Block 502 as “The weather in New York City is warm and humid with afternoon showers expected.”. The data source B1 is shown in Block 503 as the weather portal Accuweather^{®}. In one or more implementations, a pre-trained LLM may be prompted by one or more prompts to generate the example annotated dataset of Block 502, using the definitions provided in Block 503.

Block 504 shows an example of a user prompt, and two corresponding response segments generated by the response generator. The first response segment may be generated by the response generator by retrieving data from the data source identified by [A1], namely, California tax code and forms. The response segment generated is shown in Block 504 as “You can file your taxes by completing form 540. Remember to file your federal taxes as well.” However, this response segment introduces a new context, namely, Federal tax code and forms. Accordingly, the response generator injects a new data source token, namely, [A2] into the first response segment. The second response segment is generated by retrieved data from [A2]. The response generator makes a determination precluding further retrieval when processing the second response segment and generates the final response, shown in Block 504 as a combination of the first response segment and the second response segment.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 6A, the computing system (600) may include one or more computer processor(s) (602), non-persistent storage device(s) (604), persistent storage device(s) (606), a communication interface (608) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) (602) may be one or more cores, or micro-cores, of a processor. The computer processor(s) (602) includes one or more processors. The computer processor(s) (602) may include a central processing unit (CPU), a graphics processing unit (GPU), a tensor processing unit (TPU), combinations thereof, etc.

The input device(s) (610) may include a touchscreen, keyboard, mouse, microphone, touchpad, electronic pen, or any other type of input device. The input device(s) (610) may receive inputs from a user that are responsive to data and messages presented by the output device(s) (612). The inputs may include text input, audio input, video input, etc., which may be processed and transmitted by the computing system (600) in accordance with one or more embodiments. The communication interface (608) may include an integrated circuit for connecting the computing system (600) to a network (not shown) (e.g., a local area network (LAN), a wide area network (WAN) such as the Internet, mobile network, or any other type of network) or to another device, such as another computing device, and combinations thereof.

Further, the output device(s) (612) may include a display device, a printer, external storage, or any other output device. One or more of the output device(s) (612) may be the same or different from the input device(s) (610). The input device(s) (610) and output device(s) (612) may be locally or remotely connected to the computer processor(s) (602). Many different types of computing systems exist, and the aforementioned input device(s) (610) and output device(s) (612) may take other forms. The output device(s) (612) may display data and messages that are transmitted and received by the computing system (600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (602), is configured to perform one or more embodiments, which may include transmitting, receiving, presenting, and displaying data and messages described in the other figures of the disclosure.

The computing system (600) in FIG. 6A may be connected to, or be a part of, a network. For example, as shown in FIG. 6B, the network (620) may include multiple nodes (e.g., node X (622) and node Y (624), as well as extant intervening nodes between node X (622) and node Y (624)). Each node may correspond to a computing system, such as the computing system shown in FIG. 6A, or a group of nodes combined may correspond to the computing system shown in FIG. 6A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (600) may be located at a remote location and connected to the other elements over a network.

The nodes (e.g., node X (622) and node Y (624)) in the network (620) may be configured to provide services for a client device (626). The services may include receiving requests and transmitting responses to the client device (626). For example, the nodes may be part of a cloud computing system. The client device (626) may be a computing system, such as the computing system shown in FIG. 6A. Further, the client device (626) may include or perform all or a portion of one or more embodiments.

The computing system of FIG. 6A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
obtaining a plurality of data source tokens, identifying a corresponding plurality of data sources;
adding the plurality of data source tokens to a vocabulary list of a response tokenizer of a response foundation model;
updating an internal mapping of the response tokenizer with the plurality of data source tokens to map each data source token of the plurality of data source tokens to a corresponding token identifier (ID);
adding a plurality of vector representations corresponding to the plurality of data source tokens to a response embedding model of the response foundation model;
creating an annotated dataset comprising a plurality of instances, each instance comprising an input utterance, a retrieved data, and a data source token, wherein the retrieved data is retrieved from a data source corresponding to the data source token; and
training the response foundation model with the annotated dataset to output data source tokens for a new input utterance based on a context of the new input utterance.

2. The method of claim 1, further comprising:
training the response foundation model to output data source tokens by maximizing a conditional language modeling objective; and
adjusting weights and parameters of the response foundation model to minimize a next token prediction loss function value.

3. The method of claim 1, further comprising:
creating a training dataset for the response foundation model, including at least an input-output pair comprising a training input and a training output, by:
augmenting the training input with at least a training data source token by a training application, wherein the training data source token is selected based on a training context corresponding to the training input and the training output, wherein the training output includes a training retrieved data retrieved from a training data source corresponding to the training data source token.

4. The method of claim 1, further comprising:
training the response foundation model with a training dataset to output a response segment by:
training the response foundation model to invoke a document retriever to retrieve data from a data source identified by a training data source token in a training input of the training dataset, and
training the response foundation model to generate the response segment based on the training input and the retrieved data.

5. The method of claim 1, further comprising:
receiving, by a response generator, a prompt from an enterprise application;
determining a prompt context corresponding to the prompt by the response foundation model, wherein the response generator includes the response foundation model;
augmenting the prompt with at least one new data source token, based on the prompt context by the response foundation model; and
retrieving at least one new retrieved data from a new data source identified by the new data source token by a document retriever.

6. The method of claim 1, further comprising:
receiving, by a response generator, a prompt from an enterprise application, and at least one new retrieved data from a document retriever, the at least one new retrieved data corresponding to a new data source identified by a new data source token, wherein the response generator includes the response foundation model; and
generating, by the response foundation model, a first response segment based on the at least one new retrieved data.

7. The method of claim 1, further comprising:
evaluating, by a response generator, a relevance of a first response segment based on a prompt and the first response segment; and
evaluating, by the response generator, a validity of the first response segment based on a semantic similarity of the first response segment to an at least one retrieved data of a new data source identified by a new data source token in the prompt.

8. The method of claim 7, further comprising:
evaluating, by the response foundation model of the response generator, a utility of the first response segment, based on the relevance of the first response segment and the validity of the first response segment.

9. The method of claim 1, further comprising:
identifying, by a response foundation model of a response generator, a second new data source based on the context of a first response segment; and
augmenting, by the response foundation model of the response generator, the first response segment with a second new data source token identifying the second new data source.

10. A method comprising:
augmenting a prompt with at least one new data source token by a response foundation model of a response generator;
retrieving at least one new retrieved data from a new data source identified by the new data source token by a document retriever invoked by the response generator;
generating a first response segment based on the at least one new retrieved data by the response foundation model;
evaluating, by the response generator, a relevance of the first response segment;
evaluating, by the response generator, a validity of the first response segment;
evaluating, by the response generator, a utility of the first response segment, based on the relevance of the first response segment and the validity of the first response segment; and
responsive to a determination of an additional retrieval based on a context of the first response segment, augmenting the first response segment with a second new data source token by the response foundation model.

11. The method of claim 10, further comprising:
retrieving at least a second new retrieved data from a second new data source identified by the second new data source token by the document retriever; and
generating a second response segment based on at least the second new retrieved data by the response foundation model.

12. The method of claim 11, further comprising:
generating a final response including at least the first response segment and the second response segment, based on a first utility of the first response segment and a second utility of the second response segment; and
transmitting the final response to an enterprise application by the response generator.

13. The method of claim 10, further comprising:
responsive to the determination by the response generator precluding the additional retrieval, transmitting a final response obtained by combining previous response segments to an enterprise application by the response generator.

14. The method of claim 10, wherein augmenting the prompt further comprises:
receiving, by the response generator, the prompt from an enterprise application;
determining the context of the prompt by the response foundation model; and
augmenting the prompt with the at least one new data source token, based on the context of the prompt by the response foundation model.

15. The method of claim 10, wherein the relevance of the first response segment is evaluated based on the prompt and the first response segment.

16. The method of claim 10, wherein the validity of the first response segment is evaluated based on a semantic similarity of the first response segment to the at least one new retrieved data of the new data source.

17. A system comprising:
memory; and
at least one computer processor configured to execute instructions for causing the system to perform operations comprising:
augmenting a prompt with at least one new data source token by a response foundation model of a response generator,
retrieving at least one new retrieved data from a new data source identified by the new data source token by a document retriever invoked by the response generator,
generating a first response segment based on the at least one new retrieved data by the response foundation model,
evaluating, by the response generator, a relevance of the first response segment,
evaluating, by the response generator, a validity of the first response segment,
evaluating, by the response generator, a utility of the first response segment, based on the relevance of the first response segment and the validity of the first response segment, and
responsive to a determination of an additional retrieval based on a context of the first response segment, augmenting the first response segment with a second new data source token by the response foundation model.

18. The system of claim 17, wherein the at least one computer processor is further configured to execute the instructions for causing the system to perform the operations comprising:
retrieving at least a second new retrieved data from a second new data source identified by the second new data source token by the document retriever; and
generating a second response segment corresponding to the prompt based on at least the second new retrieved data by the response foundation model.

19. The system of claim 18, wherein the at least one computer processor is further configured to execute the instructions for causing the system to perform the operations comprising:
generating a final response including at least the first response segment and the second response segment, based on a first utility of the first response segment and a second utility of the second response segment; and
transmitting the final response to an enterprise application by the response generator.

20. The system of claim 17, wherein the at least one computer processor is further configured to execute the instructions for causing the system to perform the operations comprising:
responsive to a determination precluding the additional retrieval, transmitting a final response obtained by combining previous response segments to an enterprise application by the response generator.
